(19) United States
(12) Patent Application Publication
(10) Pub. No.: US 2014/0193642 A1
(43) Pub. Date: Jul. 10, 2014

(54) Non-Caking Mine Rock Dust

(71) Applicant: Imery Pigments, Inc., Roswell, GA (US)

(72) Inventors: David Anstine, Canton, GA (US); Dickey Shurling, JR., Sandersville, GA (US)

(73) Assignee: Imery Pigments, Inc., Roswell, GA (US)

(21) Appl. No.: 14/151,004

(22) Filed: Jan. 9, 2014

Related U.S. Application Data
(60) Provisional application No. 61/750,564, filed on Jan. 9, 2013.
(60) Provisional application No. 61/787,654, filed on Mar. 15, 2013.

(51) Int. Cl. C09K 15/06

(52) U.S. Cl. CPC C09K 15/06
USPC 428/402; 252/400.1

(57) ABSTRACT

A composition for use as rock dust is disclosed. The composition may include a ground inorganic particulate material treated with at least one fatty acid, a salt thereof, or an ester thereof. Also disclosed is a composition including coal dust and mine rock dust, which may include a ground inorganic particulate material treated with at least one fatty acid, a salt thereof, or an ester thereof. The amount of mine rock dust may be sufficient to render the coal dust explosively inert. The composition may also include an untreated inorganic particulate material. The treated inorganic particulate material may be calcium carbonate. The untreated inorganic particulate material may be calcium carbonate. The fatty acid may be stearic acid.

### CROSS-REFERENCE TO RELATED APPLICATIONS

This application claims the benefit of priority of U.S. Provisional Application Nos. 61/750,564, filed Jan. 9, 2013, and 61/787,654, filed Mar. 15, 2013, the disclosures of which are incorporated herein by reference.

### FIELD OF DISCLOSURE

Disclosed herein are compositions for use as rock dust to abate explosions in mines, such as coal mines.

### BACKGROUND OF THE DISCLOSURE

For many years limestone-based rock dust has been the mine rock dust of choice for explosion abatement. Typically limestone mine rock dusts are readily available throughout North America and prevent the propagation of an explosion when applied in a proper manner to all mine surfaces and used in the correct proportion to the coal dust generated during the mining process.

However, in 2011, the National Institute of Occupation Safety and Health (NIOSH) reported that examinations of rock dust samples tended to cake when wetted and subsequently dried. The report revealed that the examined samples formed cakes and were not easily dispersed with the subjective requirement of a “light blast of air.” The rock dust samples NIOSH analyzed contained very fine (e.g., less than 10 microns) particles. Fine particles enhance the caking potential of rock dust when wetted.

Therefore, it would be desirable to produce an economically-viable modified limestone-based rock dust that will be capable of passing the caking evaluation tests established by NIOSH and effectively inerting coal dust.

### SUMMARY OF THE DISCLOSURE

According to a first aspect, a composition may include mine rock dust including a dry ground inorganic particulate material treated with at least one fatty acid, a salt thereof, or an ester thereof. The composition may further include an untreated inorganic particulate material.

According to another aspect, a composition may include coal dust and mine rock dust including a dry ground inorganic particulate material treated with at least one fatty acid, a salt thereof, or an ester thereof. The amount of mine rock dust may be sufficient to render the coal dust explosively inert. The composition may further include an untreated inorganic particulate material.

### DESCRIPTION OF EXEMPLARY EMBODIMENTS

According to some embodiments, an anti-caking mine rock dust includes a ground inorganic particulate material (e.g., a mineral) treated with at least one fatty acid, a salt thereof, or an ester thereof.

According to some embodiments, a composition includes coal dust and mine rock dust including a ground inorganic particulate material treated with at least one fatty acid, a salt thereof, or an ester thereof. The amount of mine rock dust may be sufficient to render the coal dust explosively inert.

In particular embodiments, the inorganic particulate materials may include calcium carbonate, such as, for example, marble or limestone (e.g., ground calcite or ground dolomite). Hereafter, certain embodiments of the invention may tend to be discussed in terms of calcium carbonate, and in relation to aspects where the calcium carbonate is processed and/or treated. The invention should not be construed as being limited to such embodiments. For instance, calcium carbonate may be replaced, either in whole or in part, with, for example, talc.

In certain embodiments, the at least one fatty acid, salt thereof, or ester thereof may be one or more fatty acid, salt thereof, or ester thereof with a chain length of C16 or greater. The fatty acid may, for example, be stearic acid.

In certain embodiments, the ground inorganic particulate material may have a Hegman of about 5.5 or less, as measured by ASTM D1210.

In some embodiments, the ground inorganic particulate material has a brightness of 95 or less, as measured using Hunter Colorimeter Models D-25A-9 or DP 9000.

In some embodiments, the ground inorganic particulate material may have a BET surface area of at least about 0.3 square meters/gram. For example, the ground inorganic particulate material may have a BET surface area of at least about 0.4 square meters/gram, at least about 0.5 square meters/gram, or at least about 0.6 square meters/gram.

In some embodiments, the treated ground mineral may be a dry ground treated inorganic particulate material or a wet treated ground inorganic particulate material.

In certain embodiments, the mine rock dust may also include an untreated inorganic particulate material blended with treated inorganic particulate material. In particular embodiments, the anti-caking mine rock dust may include a blend of coarse untreated ground mineral such as, for example, talc, limestone (e.g., ground calcium carbonate (GCC), ground calcite, ground dolomite), chalk, marble, and fine treated ground mineral such as talc, limestone (e.g., GCC, ground calcite, ground dolomite). In other embodiments, the untreated inorganic particulate may include gypsum, diatomaceous earth, perlite, hydrous or calcined kaolin, attapulgite, bentonite, montmorillonite, and other natural or synthetic clays. In some embodiments, blending a fine treated ground limestone with a coarser untreated limestone results in a mine rock dust that exhibits some hydrophobic properties and less caking when put in contact with water versus untreated limestone alone. The effectiveness of certain embodiments of the mine rock dust in inerting coal dust may be shown by explosibility tests, such as, the 20-L explosibility test or ASTM E1515.

In some embodiments, the untreated inorganic particulate may be a dry ground inorganic particulate material or a wet ground inorganic particulate material.

In some embodiments, the blended ground inorganic particulate material has a range of contact angles from 10 to 150 degrees. According to some embodiments, the blended ground inorganic particulate material has a range of contact angles from 25 to 125 degrees, or from 50 to 100 degrees.

Without wishing to be bound by a particular theory, it is believed that the ratio of the treated ground inorganic particulate material to untreated inorganic particulate material may be proportioned to vary the amount of un-reacted stearic acid in the blends. In certain embodiments, stearic acid-treated ground calcium carbonate may be used to provide a hydrophobic property to the rock dust. Without wishing to be bound by a particular theory, addition of stearic acid may result in minimal “free acid” after treatment. The reaction of stearic acid with the limestone surface may create calcium or magnesium stearate. The melting point of stearic acid is approximately 157° F. (69.4° C.), and the melting point of calcium stearate is approximately 311° F. (155° C.).

According to some embodiments, calcium carbonate is combined (e.g., blended) at room temperature with stearic acid (or salts thereof, ester thereof, or mixtures thereof) and water in an amount greater than about 0.1% by weight relative to the total weight of the mixture (e.g., in the form of a cake-mix). The mixture may be blended at a temperature sufficient for at least a portion of the stearic acid to react (e.g., sufficient for a majority of the stearic acid to react with at least a portion of the calcium carbonate). For instance, the mixture may be blended at a temperature sufficient such that at least a portion of the stearic acid may coat at least a portion of the calcium carbonate (e.g., the surface of the calcium carbonate).

Without being bound by a particular theory, in some embodiments, the mixture may be blended at a temperature high enough to melt the stearic acid. For example, the mixture may be blended at a temperature ranging from about 149° F. (65° C.) to about 392° F. (200° C.). In other embodiments, the mixture may be blended at a temperature ranging from about 149° F. (65° C.) to about 302° F. (150° C.), for example, at about 248° F. (120° C.). In further embodiments, the mixture may be blended at a temperature ranging from about 149° F. (65° C.) to about 212° F. (100° C.). In still other embodiments, the mixture may be blended at a temperature ranging from about 149° F. (65° C.) to about 194° F. (90° C.). In further embodiments, the mixture may be blended at a temperature ranging from about 158° F. (70° C.) to about 194° F. (90° C.).

In certain embodiments, the amount of stearic acid may be combined with calcium carbonate below, at, or in excess of, a monolayer concentration. “Monolayer concentration,” as used herein, refers to an amount sufficient to form a monolayer on the surface of the calcium carbonate particles. Such values will be readily calculable to one skilled in the art based on, for example, the surface area of the calcium carbonate particles.

In some embodiments, stearic acid may be added to calcium carbonate in an amount greater than or equal to about 1 times the monolayer concentration. In other embodiments, stearic acid may be added in an amount in excess of about 1 times the monolayer concentration, for example, two times to six times the monolayer concentration.

Also, without wishing to be bound by a particular theory, the median particle sizes of the coarse untreated mine rock dusts may be chosen based on their potential to pack with the median particle size of the specific treated mine rock dust used in that blend. The advantage of blending the smaller particles with the larger particles is that the voids between the larger particles that would wick moisture into the blend are reduced or avoided. In certain embodiments, particle packing practice may be used to inhibit the wicking action of surface water through the powder.

In certain embodiments, the calcium carbonate may be characterized by a mean particle size (d₅₀) value, defined as the size at which 50 percent of the calcium carbonate particles have a diameter less than or equal to the stated value. Particle size measurements, such as d₅₀, may be carried out by any means now or hereafter known to those having ordinary skill in the art.

Particle sizes, and other particle size properties, of the untreated inorganic particulate material referred to in the present disclosure, may be measured using a SEDIGRAPH 5100 instrument, as supplied by Micromeritics Corporation. The size of a given particle is expressed in terms of the diameter of a sphere of equivalent diameter, which sediments through the suspension, i.e., an equivalent spherical diameter or esd.

The particle size and other particle size properties of the treated inorganic particulate material may be determined by a Microtrac Model X100 Particle Size Analyzer, as supplied by Microtrac. The Microtrac analysis determines particle size based on the number distribution of particles using a laser light scattering technique.

In some embodiments, the particle size as determined by SEDIGRAPH 5100 may not be the same as that determined by a Microtrac Model X100 Particle Size Analyzer. The difference may be due to the different methods used by each instrument to determine the particle size. The SEDIGRAPH 5100 measures the sedimentation of particles over time, whereas the Microtrac Model X100 Particle Size Analyzer analyzes a laser light scattering pattern using a specific algorithm.

According to some embodiments, the amount of free stearic acid associated with the stearic acid-treated calcium carbonate composition may be less than about 20% relative to the monolayer concentration. According to other embodiments, the amount of free stearic acid associated with the stearic acid-treated calcium carbonate composition may be less than about 15% free stearic acid. According to further embodiments, the amount of free stearic acid associated with the stearic acid-treated calcium carbonate composition may be less than about 10% free stearic acid, less than about 7% free stearic acid, less than about 6% free stearic acid, less than about 5% free stearic acid, less than about 4% free stearic acid, less than about 3% free stearic acid, less than about 2% free stearic acid, or less than about 1% free stearic acid. In still further embodiments, no free stearic acid may be associated with the stearic acid-treated calcium carbonate composition. “No free stearic acid,” as used herein, refers to no stearic acid being detectable by the ToF-SIMS, TGA, and/or DSC techniques described herein.

According to some embodiments, the treated ground inorganic particulate material and the untreated inorganic particulate material have the same particle size distribution (psd). Without being bound by a particular theory, the psd of the fine particles may be similar to, or the same as, the psd of the coarse portion of the mine rock dust.

An exemplary anti-caking mine rock dust is now described. The mine rock dust may be such that a minimum of 70% of the particles passes through a 200 mesh. In some embodiments, the d₅₀ ranges from about 10 to about 50 microns; no more than about 0.4 wt % stearic acid is present (without wishing to be bound by a particular theory, too much stearic acid may affect whether the mine rock dust will adhere properly to the mine walls and ceilings); and the ratio of the fine treated portion to the coarse untreated portion ranges from 10:90 to 75:25. The fine portion may be treated with stearic acid, silicone oil, or silane, although silane may not be used to treat limestone. For the stearic acid treatment, it is preferred to have reacted stearate on the mineral, as it has a higher melting point (311° F.) relative to unreacted (free) stearic acid (157° F.). By having less of the lower melting point material, less flashing of the treatment occurs during an explosion or increase in temperature when the composition is in use. Thus, the rock mine dust will be more effective in abating an explosion.

In certain embodiments, the treatment level ranges from 0.1 wt % to 2.5 wt %. For instance, the fatty acid, salt thereof, or ester thereof may be present in an amount of not more than 0.2 wt %, not more than 0.3 wt %, not more than 0.4 wt %, not more than 0.5 wt %, not more than 0.6 wt %, not more than 0.7 wt %, not more than 0.8 wt %, not more than 0.9 wt %, not more than 1.0 wt %, not more than 1.1 wt %, not more than 1.2 wt %, not more than 1.25 wt %, not more than 1.3 wt %, not more than 1.4 wt %, not more than 1.5 wt %, not more than 1.6 wt %, not more than 1.7 wt %, not more than 1.8 wt %, not more than 1.9 wt %, not more than 2.0 wt %, not more than 2.1 wt %, not more than 2.2 wt %, not more than 2.3 wt %, not more than 2.4 wt %, or not more than 2.5 wt % based on the weight of the inorganic particulate material.

In certain embodiments, the fine treated ground inorganic particulate material d₅₀ ranges from 1 to 15 microns. In other embodiments, the fine treated ground inorganic particulate material d₅₀ ranges from 1 to 75 microns, from 1 to 60 microns, from 1 to 50 microns, or from 1 to 30 microns.

In other embodiments, the coarse portion d₅₀ may range from 10 to 75 microns, for example, from 12 to 75 microns, from 20 to 75 microns, from 25 to 75 microns, or from 30 to 75 microns.

In certain embodiments, the ratio of treated ground inorganic particulate material to untreated inorganic particulate material ranges from about 1:99 to about 99:1, for example, from about 5:95 to about 95:5, or from about 25:75 to about 75:25.

According to some embodiments, the untreated dry ground inorganic particulate material d₅₀ ranges from 5 to 50 microns or from 10 to 50 microns.

Three example mine rock dusts may be made according to the exemplary test method outlined below and passed the exemplary test:
1. 50% coarse (12-18 micron) ground limestone with 50% 3 micron median stearate-treated ground limestone blend;
2. 25% coarse (12-18 micron) ground limestone with 75% 3 micron median stearate-treated ground limestone blend; and
3. 75% coarse (12-18 micron) ground limestone with 25% 3 micron median stearate-treated ground limestone blend.

In some embodiments, the ground calcium carbonate is prepared by attrition grinding. “Attrition grinding,” as used herein, refers to a process of wearing down particle surfaces resulting from grinding and shearing stress between the moving grinding particles. Attrition can be accomplished by rubbing particles together under pressure, such as by a gas flow.

In some embodiments, the attrition grinding is performed autogenously, where only the calcium carbonate particles are ground only by other calcium carbonate particles.

In another embodiment, the calcium carbonate is ground by the addition of a grinding media other than calcium carbonate. Such additional grinding media can include ceramic particles (e.g., silica, alumina, zirconia, and aluminum silicate), plastic particles, or rubber particles.

In some embodiments, the calcium carbonate is ground in a mill. Exemplary mills include those described in U.S. Pat. Nos. 5,238,193 and 6,634,224, the disclosures of which are incorporated herein by reference. As described in these patents, the mill may comprise a grinding chamber, a conduit for introducing the calcium carbonate into the grinding chamber, and an impeller that rotates in the grinding chamber thereby agitating the calcium carbonate.

In some embodiments, the calcium carbonate is dry ground, where the atmosphere in the mill is ambient air. In some embodiments, the calcium carbonate may be wet ground.

In some embodiments, the mine rock dust may have a range of contact angles from 10 to 150 degrees, from 25 to 125 degrees, or from 50 to 100 degrees, as measured by a test according to ASTM D7334-08. For example, a stearate-treated calcium carbonate may be blended with an untreated calcium carbonate in a ratio (treated:untreated) of 12.5:87.5. The treated calcium carbonate may be treated with 1.15 wt % of stearate and may have a d₅₀ value of 3.3 microns, as measured by Microtrac laser light diffraction. The untreated calcium carbonate may have a d₅₀ value of 22.5 microns, as measured by a SEDIGRAPH 5100. The contact angle of the blended composition may be measured according to ASTM D7334-08. The exemplary blended composition has a contact angle of 93 degrees at 35% relative humidity, and 95.5 degrees at 98% relative humidity.

In some embodiments, a feed calcium carbonate (prior to milling) may comprise calcium carbonate sources chosen from calcite, limestone, chalk, marble, dolomite, etc. Ground calcium carbonate particles can be prepared by any known method, such as by conventional grinding techniques discussed above and optionally coupled with classifying techniques, e.g., jaw crushing followed by roller milling or hammer milling and air classifying or mechanical classifying.

The ground calcium carbonate may be further subjected to an air sifter or hydrocyclone. The air sifter or hydrocyclone can function to classify the ground calcium carbonate and remove a portion of residual particles greater than 20 microns. According to some embodiments, the classification can be used to remove residual particles greater than 10 microns, greater than 30 microns, greater than 40 microns, greater than 50 microns, or greater than 60 microns. According to some embodiments, the ground calcium carbonate may be classified using a centrifuge, hydraulic classifier, or elutriator.

In some embodiments, the ground calcium carbonate disclosed herein is free of dispersant, such as a polyacrylate. In another embodiment, a dispersant may be present in a sufficient amount to prevent or effectively restrict flocculation or agglomeration of the ground calcium carbonate to a desired extent, according to normal processing requirements. The dispersant may be present, for example, in levels up to about 1% by weight. Examples of dispersants include polyelectrolytes such as polyacrylates and copolymers containing polyacrylate species, especially polyacrylate salts (e.g., sodium and aluminium optionally with a group II metal salt), sodium hexametaphosphates, non-ionic polyol, polyphosphoric acid, condensed sodium phosphate, non-ionic surfactants, alkanolamine, and other reagents commonly used for this function.

A dispersant may be selected from conventional dispersant materials commonly used in the processing and grinding of inorganic particulate materials, such as calcium carbonate. Such dispersants will be recognized by those skilled in this art. Dispersants are generally water-soluble salts capable of supplying anionic species which in their effective amounts may adsorb on the surface of the inorganic particles and thereby inhibit aggregation of the particles. The unsolvated salts suitably include alkali metal cations, such as sodium. Solvation may in some cases be assisted by making the aqueous suspension slightly alkaline. Examples of suitable dispersants also include water soluble condensed phosphates, for example, polymetaphosphate salts (general form of the sodium salts: (NaPO₃)ₓ), such as tetrasodium metaphosphate or so-called “sodium hexametaphosphate” (Graham's salt); water-soluble salts of polysilicic acids; polyelectrolytes; salts of homopolymers or copolymers of acrylic acid or methacrylic acid; or salts of polymers of other derivatives of acrylic acid, suitably having a weight average molecular mass of less than about 20,000. Sodium hexametaphosphate and sodium polyacrylate, the latter suitably having a weight average molecular mass in the range of about 1,500 to about 10,000, are preferred.

In certain embodiments, the production of the ground calcium carbonate includes using a grinding aid, such as propylene glycol, or any grinding aid known to those skilled in the art.

According to some embodiments, the ground calcium carbonate may be combined with coal dust. Without wishing to be bound to a particular theory, that the ground calcium carbonate compositions disclosed may effectively render coal dust inert, as shown by an explosibility test.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising:
mine rock dust comprising a dry ground inorganic particulate material treated with at least one fatty acid, a salt thereof, or an ester thereof.

2. The composition of claim 1, wherein the mine rock dust further comprises an untreated inorganic particulate material.

3. The composition of claim 1, wherein the treated dry ground inorganic particulate material is ground calcium carbonate.

4. The composition of claim 2, wherein the untreated inorganic particulate material is calcium carbonate.

5. The composition of claim 2, wherein the ratio of treated dry ground inorganic particulate material to untreated inorganic particulate material ranges from about 1:99 to about 99:1.

6. The composition of claim 1, wherein the treated dry ground inorganic particulate material has a d₅₀ ranging from about 1 to 75 microns.

7. The composition of claim 2, wherein the untreated inorganic particulate material has a d₅₀ ranging from about 5 to about 50 microns.

8. The composition of claim 1, wherein the at least one fatty acid, salt thereof, or ester thereof comprises one or more fatty acids, salts thereof, or esters thereof with a chain length of C16 or greater.

9. The composition of claim 1, wherein the fatty acid comprises stearic acid.

10. The composition of claim 1, wherein the fatty acid, salt thereof, or ester thereof is present in an amount not greater than about 2.5% by weight of the dry ground inorganic particulate material.

11. The composition of claim 1, wherein the dry ground inorganic particulate material is substantially free of dispersant.

12. The composition of claim 1, wherein the dry ground inorganic particulate material has a Hegman of about 5.5 or less.

13. The composition of claim 1, wherein the dry ground inorganic particulate material has a BET surface area of at least about 0.3 square meters/gram.

14. The composition of claim 1, wherein the composition has a contact angle ranging from 10 to 150 degrees.

15. A composition comprising:
coal dust; and
mine rock dust comprising a dry ground inorganic particulate material treated with at least one fatty acid, a salt thereof, or an ester thereof, wherein the amount of mine rock dust is sufficient to render the coal dust explosively inert.

16. The composition of claim 15, wherein the mine rock dust further comprises an untreated inorganic particulate material.

17. The composition of claim 15, wherein the treated dry ground inorganic particulate material is ground calcium carbonate.

18. The composition of claim 16, wherein the untreated inorganic particulate material is calcium carbonate.

19. The composition of claim 15, wherein the treated dry ground inorganic particulate material has a d₅₀ ranging from about 1 to 75 microns.

20. The composition of claim 16, wherein the untreated inorganic particulate material has a d₅₀ ranging from about 5 to about 50 microns.

21. The composition of claim 15, wherein the at least one fatty acid, salt thereof, or ester thereof comprises one or more fatty acids, salts thereof, or esters thereof with a chain length of C16 or greater.

22. The composition of claim 15, wherein the fatty acid comprises stearic acid.
